(19) United States
(12) Patent Application Publication
(10) Pub. No.: US 2022/0345009 A1
(43) Pub. Date: Oct. 27, 2022

(54) DRIVE MOTOR MODULE

(71) Applicant: Nidec Corporation, Kyoto (JP)

(72) Inventors: Hiroki YOKOZAWA, Kyoto (JP); Kazuyuki YAMAMOTO, Kyoto (JP); Daisuke OGASAWARA, Kyoto (JP); Keigo NAKAMURA, Kyoto (JP)

(21) Appl. No.: 17/727,858

(22) Filed: Apr. 25, 2022

(30) Foreign Application Priority Data
Apr. 26, 2021 (JP) 2021-074127

(51) Int. Cl. H02K 11/33; H02K 5/24; H02P 27/06; H02K 7/116; H02K 7/08

(52) U.S. Cl. CPC H02K 11/33; H02K 5/24; H02P 27/06; H02K 7/116; H02K 7/083; H02K 5/04

(57) ABSTRACT

A drive motor module includes a motor, an inverter electrically connected to the motor, a gear connected to a drive shaft extending in parallel with a motor axis of the motor to transfer power from the motor to the drive shaft, and a housing including a motor housing that houses the motor, an inverter housing that houses the inverter, and a gear housing that houses the gear. The inverter housing is spaced apart from the drive shaft in a radial direction of the drive shaft. The gear housing is located at one side of the drive shaft in a longitudinal direction. and the housing includes at least one rib connecting the inverter housing and the gear housing.

### CROSS-REFERENCE TO RELATED APPLICATIONS

The present application claims priority under 35 U.S.C. § 119 to Japanese Patent Application No. 2021-074127, filed on Apr. 26, 2021, the entire contents of which are hereby incorporated herein by reference.

### 1. FIELD OF THE INVENTION

The present disclosure relates to a drive motor module.

### 2. BACKGROUND

A vibration suppression method for suppressing vibration of a motor itself or vibration transmitted from the motor is conventionally known. The vibration suppression method includes, for example, the following three methods.

The first method is a method of suppressing vibration by reducing the excitation force.

The second method is a method of suppressing vibration by increasing rigidity of a motor or a peripheral portion of the motor.

The third method is a method of suppressing vibration by elasticity of a support portion that supports a motor (vibration source).

Conventionally, the electromagnetic excitation forces of the two types of teeth (the in-phase teeth and the out-of-phase teeth) in the stator cancel each other out, and the excitation force applied to the entire stator is reduced. Thus, vibration of the motor can be suppressed.

Conventionally, the vibration component in the predetermined direction is canceled by controlling the current of the motor, and the vibration of the entire motor is suppressed.

Conventionally, a plurality of reinforcing ribs is provided on a flange portion of a motor frame that houses a motor. The plurality of reinforcing ribs can increase the rigidity of the motor frame. Accordingly, even when vibration from the motor is transmitted to the motor frame, resonance of the motor frame can be suppressed.

Conventionally, a support portion that supports a vibration source (engine) has elasticity. By increasing the spring rigidity of the support portion, vibration from the vibration source can be attenuated.

The motor may be housed in a housing together with an inverter that supplies drive power to the motor to be modularized (unitized).

In addition, conventional motors can suppress vibration, but cannot completely eliminate the vibration. When these conventional motors are modularized, vibration is inevitably transmitted to the housing, so that the housing may resonate to generate noise.

### SUMMARY

An example embodiment of a drive motor module of the present disclosure includes a motor, an inverter electrically connected to the motor, a gear connected to a drive shaft extending in parallel with a motor axis of the motor to transfer power from the motor to the drive shaft, and a housing including a motor housing that houses the motor, an inverter housing that houses the inverter, and a gear housing that houses the gear. The inverter housing is spaced apart from the drive shaft in a radial direction of the drive shaft. The gear housing is located at one side of the drive shaft in a longitudinal direction. The housing includes at least one rib connecting the inverter housing and the gear housing.

The above and other elements, features, steps, characteristics and advantages of the present disclosure will become more apparent from the following detailed description of the example embodiments with reference to the attached drawings.

### BRIEF DESCRIPTION OF THE DRAWINGS

FIG. 1 is a schematic perspective view of a drive motor module according to an example embodiment of the present disclosure.

FIG. 2 is a view (side view) when viewed from a direction of an arrow A in FIG. 1.

FIG. 3 is a schematic side view of the housing illustrated in FIG. 2.

FIG. 4 is a view (perspective view) when viewed from a direction of an arrow B in FIG. 1.

### DETAILED DESCRIPTION

Hereinafter, drive motor modules according to preferred embodiments of the present disclosure will be described in detail with reference to the accompanying drawings.

In the following description, the gravity direction is defined based on the positional relationship when the drive motor module is mounted on a vehicle located on a horizontal road surface. In the drawings, an XYZ coordinate system is shown appropriately as a three-dimensional orthogonal coordinate system. In the XYZ coordinate system, the Z-axis direction indicates the vertical direction (that is, the up-down direction), the +Z direction is upward (opposite to the gravity direction), and the −Z direction is downward (gravitational direction). The X-axis direction is a direction orthogonal to the Z-axis direction and indicates a front-rear direction of the vehicle on which the drive motor module is mounted. A Y-axis direction is a direction perpendicular to both the X-axis direction and the Z-axis direction, and is a width direction (right-left direction) of the vehicle.

In the following description, unless otherwise specified, a direction (the Y-axis direction) parallel to a motor axis of a motor will be simply referred to by the term “axis direction”, “axial”, or “axially”, radial directions centered on the motor axis will be simply referred to by the term “radial direction”, “radial”, or “radially”, and a circumferential direction centered on the motor axis, i.e., a circumferential direction about the motor axis, will be simply referred to by the term “circumferential direction”, “circumferential”, or “circumferentially”. In the present example embodiment, “one side in the axis direction” is a positive side in the Y-axis direction, and “the other side in the axis direction” is a negative side in the Y-axis direction.

In the present specification, “extending (provided) along” a predetermined direction (or plane) includes not only extending strictly in the predetermined direction but also extending in a direction inclined within a range of less than 45° with respect to the strict predetermined direction.

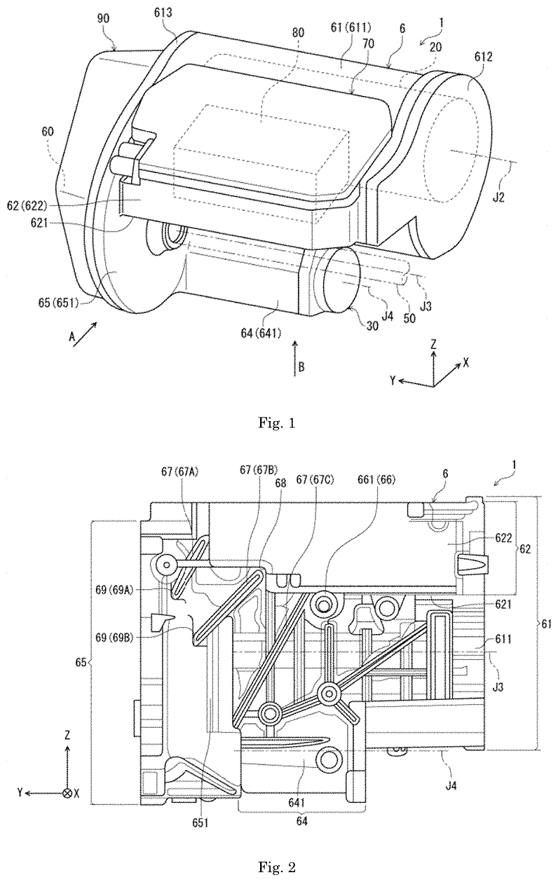

A drive motor module 1 illustrated in FIG. 1 is mounted on a vehicle using a motor as a power source, such as a hybrid electric vehicle (HEV), a plug-in hybrid electric vehicle (PHV), or an electric vehicle (EV), and is used as the power source. That is, the drive motor module 1 is a drive device.

The drive motor module 1 includes a motor (main motor) 20, an inverter 80, a differential device 60, an oil pump 30, a housing 6, an inverter cover 70, and a gear cover 90. The drive motor module 1 further includes a deceleration device (not illustrated) and the like.

The motor 20 is accommodated (housed) in the housing 6. The motor 20 includes a rotor that rotates about a motor axis (axis) J2 extending in the horizontal direction, and a stator located radially outside the rotor. The motor 20 of the present example embodiment is an inner rotor type motor, and the rotor rotates when an alternating current is supplied from a battery (not illustrated) to the stator via the inverter 80. In the present example embodiment, a motor axis J2 is parallel to the Y-axis direction.

Oil as a refrigerant circulates inside the motor 20. The motor 20 is thus cooled. The oil is circulated by the operation of the oil pump 30. The oil pump 30 is not particularly limited, and may be, for example, any of an inscribed gear type and a circumscribed gear type.

A deceleration device is connected to the rotor of the motor 20. The deceleration device has a function of reducing a rotation speed of the motor 20 to increase torque output from the motor 20 according to a reduction ratio. The deceleration device transfers the torque output from the motor 20 to the differential device 60.

The differential device 60 is connected to the motor 20 via the deceleration device. The differential device 60 includes a differential gear (not illustrated) coupled to a drive shaft 50 extending in parallel with the motor axis J2 of the motor 20. Then, the torque (power) output from the motor 20 can be transferred to the wheels of the vehicle via the drive shaft 50. In addition, the differential device 60 has a function of transferring the torque to the left and right wheels while absorbing the difference in speed between the left and right wheels when the vehicle turns.

As in the motor 20, the inverter 80 is also housed in the housing 6. The inverter 80 is electrically connected to the motor 20. The inverter 80 includes a control element that controls power supplied to the motor 20. The control element is, for example, an IGBT.

The housing 6 includes a motor housing 61 that houses the motor 20, an inverter housing 62 that houses the inverter 80, a gear housing 65 that houses the gear of the differential device 60, and an oil pump mounting portion 64 to which the oil pump 30 is mounted.

The housing 6 is an integrally molded product in which the motor housing 61, the inverter housing 62, the gear housing 65, and the oil pump mounting portion 64 are integrated. The motor housing 61, the inverter housing 62, the gear housing 65, and the oil pump mounting portion 64 may be configured as separate bodies, and the separate bodies may be connected (fixed) to each other.

As illustrated in FIG. 1, the motor housing 61 is disposed apart from the drive shaft 50 in the radial direction thereof, and is disposed apart from the drive shaft 50 in the +X direction in the present example embodiment.

The inverter housing 62 is also disposed apart from the drive shaft 50 in the radial direction thereof, and is disposed apart from the drive shaft 50 in the +Z direction in the present example embodiment.

A gear housing 65 is located on the center axis J3 of the drive shaft 50 and is disposed in the +Y direction (one side of the center axis J3) relative to the motor housing 61 and the inverter housing 62.

As in the motor housing 61 and the inverter housing 62, the oil pump mounting portion 64 is disposed apart from the drive shaft 50 in the radial direction. In the present example embodiment, the oil pump mounting portion 64 is disposed adjacent to the motor housing 61 in the −Z direction.

The motor housing 61 has a cylindrical wall portion 611 that surrounds the motor 20 around the motor axis J2. The motor housing 61 has a wall portion 612 that closes the wall portion 611 from the −Y direction and a wall portion 613 that closes the wall portion 611 from the +Y direction. The motor 20 can be housed in a space surrounded by the wall portion 611, the wall portion 612, and the wall portion 613.

The inverter housing 62 has a bottom portion 621 parallel to the XY plane and a side wall portion (wall portion) 622 provided along an edge portion of the bottom portion 621. Then, the inverter 80 can be housed in a space surrounded by the bottom portion 621 and the side wall portion 622.

The inverter cover 70 is attached to the inverter housing from the +Z direction so as to cover the inverter 80. Accordingly, the inverter 80 can be protected.

The gear housing 65 has a funnel-shaped wall portion 651 centered on the center axis J3. The gear of the differential device 60 can be housed inside the wall portion 651.

In addition, the gear cover 90 is attached to the gear housing 65 from the +Y direction so as to cover a differential gear (gear) of the differential device 60. Accordingly, the differential gear can be protected.

The oil pump mounting portion 64 has a cylindrical wall portion 641 whose center axis J4 is parallel to the Y-axis direction (motor axis J2). Then, the oil pump 30 is attached in the −Y direction of the wall portion 641.

As described above, the motor 20 is mounted on the drive motor module 1. When the motor 20 operates, vibration also occurs accordingly. This vibration is transmitted to the housing 6. Depending on the vibration frequency at this time, the housing 6 may resonate. Of the housing 6, resonance is likely to occur particularly at the inverter housing 62. One of the reasons is that the inverter housing 62 is cantilevered at the motor housing 61.

When resonating, for example, the inverter housing 62 vibrates so as to warp in the vertical direction, or vibrates so as to be closer to or be away from the gear housing 65, which may cause noise. In addition, the noise is considered to impair the comfort of the automobile.

Therefore, the drive motor module 1 is configured to suppress resonance of the inverter housing 62 in order to solve such a defect (particularly, resonance of the inverter housing 62). Hereinafter, this configuration and operation will be described.

The vibration source when the housing 6 resonates is not limited to the motor 20.

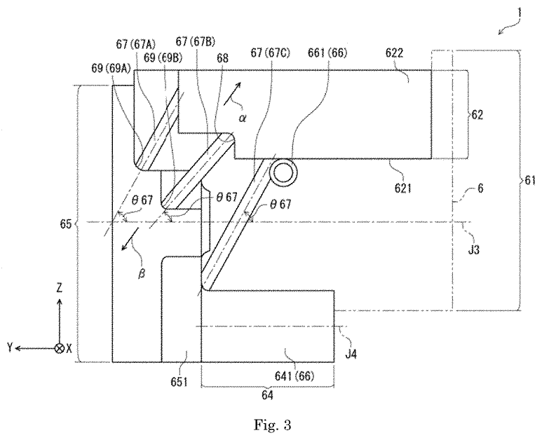

As illustrated in FIGS. 2 and 3, the housing 6 has a rib 67. In the present example embodiment, three ribs 67 are provided, but the number of ribs 67 is not limited to three, and may be, for example, one, two, or four or more. In addition, hereinafter, the three ribs 67 may be referred to as a “rib 67A”, a “rib 67B”, and a “rib 67C” in order from the +Y direction to the −Y direction.

The ribs 67A to 67C are provided with a distance therebetween in the Y-axis direction, the rib 67A connects the side wall portion 622 of the inverter housing 62 and the funnel-shaped wall portion 651 of the gear housing 65, and the rib 67B and the rib 67C connect the bottom portion 621 of the inverter housing 62 and the funnel-shaped wall portion 651 of the gear housing 65.

Each rib 67 preferably connects the inverter housing 62 and the gear housing 65 at the shortest distance as possible, that is, extends linearly in a side view.

As illustrated in FIGS. 2 and 3, the ribs 67A to 67C are provided to be inclined with respect to the center axis J3 of the drive shaft 50, that is, the longitudinal direction of the drive shaft 50 in the side view. The inclination angles θ67 of the ribs 67 with respect to the center axis J3 may be the same or different (see FIG. 3).

As described above, since the inverter housing 62 is in a cantilevered state, resonance easily occurs. In the drive motor module 1, the inverter housing 62 and the gear housing 65 are connected by the respective ribs 67, so that the inverter housing 62 can be reinforced from below. As a result, it is possible to sufficiently suppress various vibrations in which the inverter housing 62 vibrates to bend in the vertical direction or vibrates to be closer to or be away from the gear housing 65 at the time of resonance of the housing 6.

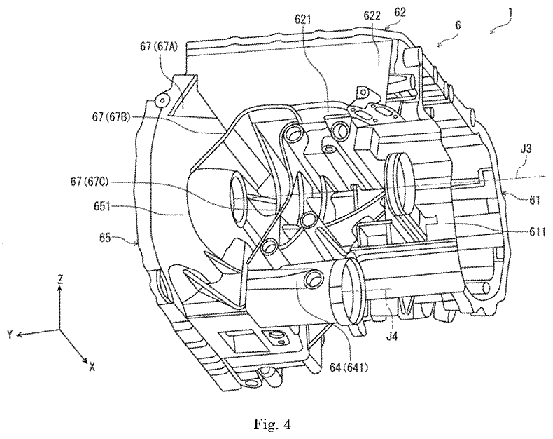

As illustrated in FIG. 4, each rib 67 is provided to protrude in a plate shape from the outer peripheral portion of the wall portion 611. As a result, the inverter housing 62 and the gear housing 65 can be more firmly reinforced by each rib 67, and the motor housing 61 can also be reinforced. As a result, resonance of the housing 6 can be further suppressed.

The amount of protrusion of each rib 67 from the wall portion 611 may be the same or different. In addition, since the rib 67C is in a positional relationship intersecting the center axis J3 of the drive shaft 50 in a side view, the amount of protrusion of the rib 67C is set to such an extent that the rib does not interfere with the drive shaft 50.

In addition, since each rib 67 has a plate shape, rigidity of the rib 67 itself can be increased, which contributes to suppression of resonance of the housing 6.

As illustrated in FIGS. 2 and 3, the bottom portion 621 of the inverter housing 62 has a first recess 68 recessed in a direction (arrow a) away from the gear housing 65. In the present example embodiment, one first recess 68 is provided, but the number of first recesses 68 is not limited to one, and may be, for example, two or more.

The wall portion 651 of the gear housing 65 has a second recess 69 recessed in a direction (arrow away from the inverter housing 62. In the present example embodiment, two second recesses are provided, but the number of second recesses 69 is not limited to two, and may be, for example, one or three or more. In addition, hereinafter, the two second recesses 69 may be referred to as a “second recess 69A” and a “second recess 69B” in order from the +Y direction to the −Y direction.

The second recess 69A and the second recess 69B are also disposed to be shifted in the Z-axis direction, and the second recess 69A is located in the +Z direction relative to the second recess 69B.

The rib 67B is connected to the first recess 68. Thus, the connection between the rib 67B and the inverter housing 62 is strengthened.

The rib 67A is connected to the second recess 69A, and the rib 67B is connected to the second recess 69B. Thus, the connection between each of the rib 67A and the rib 67B, and the gear housing 65 is strengthened.

Specifically, the rib 67B is connected to the first recess 68 and the second recess 69B, and is provided to be inclined with respect to the center axis J3 between the first recess 68 and the second recess 69B. As a result, among the three ribs 67, the rib 67B located at the center can most contribute to vibration suppression.

The housing 6 has a high rigidity portion 66 having higher rigidity than the inverter housing 62 and the gear housing 65. Examples of the high rigidity portion 66 in the present example embodiment include the wall portion 641 of the oil pump mounting portion 64, a coolant pipe portion 661 provided on the wall portion 611 of the motor housing 61, and the like. The coolant pipe portion 661 is a portion that protrudes in a tubular shape in the −X direction from the outer peripheral portion of the wall portion 611, and a coolant for cooling the motor 20 can pass therethrough. The coolant pipe portion 661 is disposed immediately below the inverter housing 62.

The rib 67C is provided in the vicinity of each high rigidity portion 66. In the present example embodiment, the lower end portion of the rib 67C is located at the boundary portion between the wall portion 641 of the oil pump mounting portion 64 and the wall portion 651 of the gear housing 65, and the upper end portion is located at the boundary portion between the bottom portion 621 of the inverter housing 62 and the coolant pipe portion 661. As a result, the rigidity of the rib 67C itself is further increased, which contributes to suppression of vibration in the inverter housing 62.

Although the drive motor module of the present disclosure is described above with reference to the illustrated example embodiment, the present disclosure is not limited thereto, and each unit constituting the drive motor module can be replaced with a unit having any configuration capable of exhibiting similar functions. Further, any component may be added.

Features of the above-described preferred example embodiments and the modifications thereof may be combined appropriately as long as no conflict arises.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. A drive motor module comprising:
a motor;
an inverter electrically connected to the motor;
a gear connected to a drive shaft extending in parallel with a motor axis of the motor to transfer power from the motor to the drive shaft; and
a housing including a motor housing that houses the motor, an inverter housing that houses the inverter, and a gear housing that houses the gear; wherein
the inverter housing is spaced apart from the drive shaft in a radial direction of the drive shaft;
the gear housing is located at one side of the drive shaft in a longitudinal direction; and
the housing includes at least one rib connecting the inverter housing and the gear housing.

2. The drive motor module according to claim 1, wherein
the motor housing includes a cylindrical wall portion and is located at a position different from the inverter housing, the position being spaced away from the drive shaft in the radial direction of the drive shaft; and
the rib protrudes from an outer peripheral portion of the wall portion.

3. The drive motor module according to claim 1, wherein the rib is inclined with respect to the longitudinal direction of the drive shaft.

4. The drive motor module according to claim 1, wherein
the inverter housing includes a first recess recessed in a direction away from the gear housing; and
the rib is connected to the first recess.

5. The drive motor module according to claim 4, wherein
the gear housing includes a second recess recessed in a direction away from the inverter housing; and
the rib is connected to the second recess.

6. The drive motor module according to claim 5, wherein the rib is inclined with respect to the longitudinal direction of the drive shaft between the first recess and the second recess.

7. The drive motor module according to claim 1, wherein
the housing includes a high rigidity portion having a higher rigidity than the inverter housing and the gear housing; and
the rib is adjacent to the high rigidity portion.

8. The drive motor module according to claim 1, wherein the rib has a plate shape.

9. The drive motor module according to claim 1, wherein a plurality of the ribs is spaced apart with a distance therebetween.
